(19) United States
(12) Patent Application Publication
(10) Pub. No.: US 2018/0060622 A1
(43) Pub. Date: Mar. 1, 2018

(54) RFID APPARATUS AND METHOD FOR COMPARTMENT OCCUPANCY DETECTION IN A SHELF

(71) Applicant: SICK AG, Waldkirch (DE)

(72) Inventors: Olaf PILZNER, Waldkirch (DE); Florian PUDENZ, Waldkirch (DE)

(21) Appl. No.: 15/674,745

(22) Filed: Aug. 11, 2017

(30) Foreign Application Priority Data
Aug. 29, 2016 (EP) 16186185.1

(51) Int. Cl. G06K 7/10; G06K 19/077

(52) U.S. Cl. CPC G06K 7/10366; G06K 19/07773

(57) ABSTRACT

An RFID apparatus for compartment occupancy detection in a shelf, the RFID apparatus including an antenna, an RF transceiver connected to the antenna and a control and evaluation unit for communicating with an RFID transponder via the RF transceiver and the antenna by means of an RFID signal and for a detection and localization of changes in the compartment occupancy. The RFID apparatus further includes a plurality of reference transponders to be arranged on the shelf at known positions, wherein the control and evaluation unit is configured to localize, upon a change of a detectable RFID transponder population, an RFID transponder which is removed or added based on the position of a reference transponder where communication characteristics of the RFID communication have changed together with the change of the detectable RFID transponder population.

The invention relates to an RFID device and a method for compartment occupancy detection in a shelf.

RFID reading systems are used for automatic identification of objects. RFID transponders attached to the objects are read and, where appropriate, information is written back into the transponder. The collected information is used to detect the location, the destination or other properties of the object and to thus control storage and flow of goods and products. There are different types of RFID transponders which differ for example in the frequencies used or in whether they operate actively with their own power supply or passively with the transmission energy of the reading system. One example is the established ultra-high frequency standard (UHF) ISO 18000-6 for passive transponders which are read according to the backscatter method.

The objects bearing the transponders are often stacked, in particular for storage, in an ordered fashion and are arranged in several layers or rows. A typical example is a rack or shelf having compartments or rows of containers. The transponders are in particular arranged on intralogistics transport boxes and are to be assigned to a shelf compartment into which they are inserted. However, a fundamental problem with the use of transponders is that the location of the transponder can only be determined with great effort. Therefore, detection of a new transponder in the field is possible in various ways, but the assignment to a specific shelf compartment based on RFID alone is not possible or only possible with great effort.

An application for the automatic detection of shelf occupancy is production process control, where the storage can be significantly reduced by knowledge of the local stocks and the current demand of raw materials and intermediate products measured by the objects taken (Kanban principle). The goal is to control material supply for the production lines as much as possible in a consumption-oriented manner: There must never be too little material at the line, but there should also not be stored too much material. Accordingly, there should be a very detailed monitoring of the material in the Kanban racks. Therefore, both transport boxes delivered and inserted as well as removed transport boxes are tracked.

Conventionally, this detection is done in various ways with different degrees of automation. There is still manual material control over route cards, which are removed from empty boxes and returned to the logistics in paper form. The detection of delivered or removed transport boxes is somewhat simplified by reading bar codes with a handheld scanner. The use of RFID transponders is also known from practice, but the RFID transponders inserted into transport boxes are read separately during the removal of containers. The information encoded in the barcodes or RFID transponders can comprise specific data records, for example, with the type of material, material quantity or destination, or it is an abstract container identifier, which only results in such detailed properties after querying and linking in a database.

There is a demand for more intelligent solutions in which the processes for loading and unloading transport boxes are automated by means of RFID technology. For this purpose, it should for example be detected based on specific transponders if and in which shelf compartment a transport box is inserted into the system, whether it is the correct shelf compartment, possibly with a visual feedback for the worker, and vice versa it should also be detected if and from which shelf compartment a transport box is removed. This also should take into account temporarily ambiguous situations for example with short incorrect movements, like a transport box briefly being held in a wrong shelf compartment, being removed and put back, or a worker moving along the shelf with other transport boxes. In addition, a flexible partitioning of the shelf compartments for different transport box widths should be possible.

Accordingly, these applications place high demands which as of yet are only inadequately met. For example, the localization and assignment can be solved by a large number of RFID antennas each having a small reading field. However, the wiring effort is immense, and it is also not ensured that the scanning cycles for all antennas are fast enough to detect all necessary movements of transport boxes.

Unpublished German utility model application with file number 202016103887 proposes inter alia to cover the shelf with relative large RFID reading fields to detect the transponders of the transport boxes. At the same time, the front of the shelf is monitored with a laser scanner so that newly detected transponders can be assigned to an intrusion into the monitoring field of the laser scanner and thus to a shelf compartment. This does not only require the additional laser scanner, but also high setup and adjustment costs in order to assign the monitoring fields in laser scanner coordinates to the shelf compartments. Other conceivable methods with lesser costs have a lower accuracy in the assignment of transport boxes to shelf compartments.

EP 2 903 086 A1 discloses an RFID reading apparatus for shelf occupancy detection. A plurality of antenna circuit cards are inserted in an elongated hollow profile. The technical complexity is comparatively high, because virtually every reading point has a tunable antenna. Thus, while a very low installation and maintenance effort is achieved, this results in a high production cost for numerous individual antennas. It is also proposed to provide additional light barriers in order to detect whether a container is located at a respective position. Although such localization completely by additional sensors is conceivable, it requires cost-intensive solutions for example with numerous light barriers, in order to actually distinguish each position on the shelf. An alternative approach is to use the antenna itself as a sensor for presence detection. However, this requires cost-intensive segmented antennas with narrowly limited reading fields and complex intelligent evaluation.

It is therefore an object of the invention to improve the compartment occupancy detection in a shelf by means of RFID.

This object is satisfied by an RFID apparatus for compartment occupancy detection in a shelf, the RFID apparatus comprising an antenna, an RF transceiver connected to the antenna and a control and evaluation unit for communicating with an RFID transponder via the RF transceiver and the antenna by means of an RFID signal and for a detection and localization of changes in the compartment occupancy, the RFID apparatus further comprising a plurality of reference transponders to be arranged on the shelf at known positions, wherein the control and evaluation unit is configured to localize, upon a change of a detectable RFID transponder population, an RFID transponder which is removed or added based on the position of a reference transponder where communication characteristics of the RFID communication have changed together with the change of the detectable RFID transponder population.

The object is also satisfied by a method for compartment occupancy detection in a shelf, wherein there is an RFID communication with RIFD transponders in the shelf via at least one antenna by means of RFID signals, and a change of compartment occupancy is detected and localized, wherein a plurality of reference transponders is arranged on the shelf at known positions and upon a change of a detectable RFID transponder population an RFID transponder which is removed or added is localized based on the position of a reference transponder where communication characteristics of the RFID communication have changed together with the change of the detectable RFID transponder population.

The RFID apparatus reads RFID transponders on the shelf and therefore detects when there is a change in the RFID transponder population, i.e. RFID transponders are added or removed. The invention starts from the basic idea to indirectly localize these RFID transponders by means of a plurality of at least two reference transponders at known positions. Upon a change in the RFID transponder population, communication characteristics of the RFID communication with the reference transponders are determined. The RFID transponder which was added or removed is localized where a reference transponder with changed communication characteristics is located. This is because the changed communication characteristics are attributed to the fact that an object has entered or been removed from the signal path to this reference transponder. A particularly illustrative special case is that the RFID signal from the reference transponder is completely shielded by the object. In this case, the localization of the event changing the RFID transponder population is based on the disappearance of a known reference transponder, and more generally on changes at a known reference transponder.

Communication characteristics are understood to be parameters of the RFID communication which are derived from the RFID signal and in particular the carrier wave itself. Thus, they are not data read from the reference transponder according to the RFID protocol, which anyway would not contain any useful information about the current position of other RFID transponders.

The detectable RFID transponder population whose change triggers a localization can be limited by filters and for example only include RFID transponders of transport boxes or exclude reference transponders. It might also be useful to detect a change in the population of the reference transponders in order to be able to replace a defective or removed reference transponder, but this is a different problem. Reference transponders are not to be localized during operation, but rather form the reference system by their known positions.

The invention has the advantage that an unambiguous assignment of objects, in particular transport boxes, to a position in a shelf or a shelf compartment is possible with the sole use of RFID. The shelf can be irradiated with relatively large RFID reading fields, thereby a division into many, very small reading field which are individually controlled be avoided. Therefore, setup and wiring costs are low. Components required for the localization, namely the reference transponders, are extremely cost-effective and can also be used very flexibly by adapting the number and arrangement. The reference transponders can be programmed with suitable shelf-specific identifications, such as shelf number, shelf plane number or compartment number, and thus simplify administration of the shelf compartments.

The assignment preferably takes place at the time of the storage of transport boxes. Throughout this specification, preferably or preferred relates to an advantageous, but completely optional feature. A Kanban rack is usually designed so that transport boxes are inserted from the rear and then move forward on sloping shelves. Therefore, localization during storage has the advantage that, after the localization, the insertion region and thus the signal path to the reference transponders is free again.

The communication characteristics preferably comprise at least one of a level and a phase of the RFID signal. The level, for example the RSSI (Received Signal Strength Indicator), mainly depends on the given distance between the RFID apparatus and the reference transponder as well as the relative orientation, but also strongly on which materials the RFID signal has to penetrate. There is thus a clear difference depending on whether or not an object like a transport box is located between antenna and reference transponder. The phase or the phase angle of the RFID response with respect to the RFID transmission signal also changes by the objects located on the signal path. Both parameters level and phase can be used individually or in combination.

The control and evaluation unit preferably is configured for a teach-in of the reference transponders and their positions. This takes place before the actual operation, or when the shelf is reconfigured. On the reference transponders, their position information is stored for example in the form of a shelf-specific identification such as a compartment number. Then, a detection of all readable RFID transponders (inventory) and a subsequent inquiry of the respective shelf-specific identification are sufficient. Preferably, the reference transponders also store information that they are reference transponders. Then, a corresponding filter can be set for the query, and only reference transponders will respond. The shelf does not even have to be cleared of objects with other RFID transponders for the teach-in.

The control and evaluation unit preferably is configured to store communication characteristics of the reference transponders as a reference for changes. The communication characteristics change with the shelf occupancy and can also be changed by external factors, such as objects next to the shelf. Therefore, they are preferably not only detected and stored as a reference once during initialization, but for example cyclically. Another possibility is to store those communication characteristics as a reference which are detected during a change of the RFID transponder population.

The control and evaluation unit preferably is configured to maintain a list of the detectable RFID transponder population. The RFID device thus has a list of all readable RFID transponders which is updated cyclically or event-based. In this way, changes can be detected that trigger a localization.

The control and evaluation unit preferably is configured to localize the RFID transponder which was removed or added based on the position of the reference transponder whose communication characteristics have changed most. It is conceivable that upon inserting or removing an object the communication to a plurality of reference transponders is changed, and in this case the largest change is assumed to be the relevant one. There are possibly large changes for neighboring reference transponders, and in that case the RFID transponder to be localized is assumed to be located between these reference transponders, possibly with a weighting based on the changes. Minor changes in the communication behavior of reference transponders can be ignored by a kind of noise threshold.

The reference transponders preferably are arranged at known, in particular regular intervals along a shelf plane. They thus form a sufficiently dense grid to locate RFID transponders with a desired spatial resolution. Preferably there is such a row of reference transponders in all shelves or shelf planes, where the intervals may vary.

A respective reference transponder preferably is arranged for each shelf compartment. This provides a clear reference to the specific compartment partitioning. It may also be a fictitious finest compartmental partition, with the possibility of combining several such compartments into one compartment during operation. This ensures the flexibility to also store transport boxes or objects of different sizes on the shelf depending on the actual requirements.

Reference transponders preferably are arranged above the shelf compartments. These reference transponders preferably are freely accessible from below and can communicate downwards without attenuation of the RFID signal, where the antenna is frequently attached. The shelf compartment in this case is framed by the antenna at the bottom and by the reference transponder at the top.

The reference transponders are preferably arranged at a bottom of the shelf compartments. In this case, they are freely accessible from above or covered by a non-conducting material. This can simply be the inversion of the arrangement of the preceding paragraph. However, it is also conceivable that both the antenna and the reference transponder are arranged at the bottom. Then, the communication characteristics change because an object set on the shelf bottom detunes the transponder antenna. This can be supported by suitable material selection of the bottom of the transport boxes. Hybrid embodiments with a part of the reference transponders above and another part at or in the bottom are possible. In a shelf where the compartments are physically divided by side walls or back walls there may also be reference transponders at or in these walls.

Movable shielding elements preferably are arranged with the reference transponders which change their position relative to a respective reference transponder when an object is added or removed. The shielding elements are in particular pushed in front of the reference transponders or are released so that reference transponders are free, which ensures a change in the communication characteristics. It is possible that the shielding elements are conducting and completely cover the reference transponder, so that the respective reference transponder virtually disappears and reappears from the RFID apparatus' point of view, but it can also be a dielectric material which changes the level or another characteristic of the RFID signal.

The reference transponders preferably are movably arranged on the shelf and change their position when an object is added or removed. Due to the changed position with respect to the antenna, the communication characteristics are changed. Preferably, the polarization direction of the reference transponders is rotated into a position or out of a position corresponding to the antenna of the RFID apparatus.

The antenna preferably is an elongated antenna extending over the shelf width or shelf height, for example a rod antenna. The antenna can also be composed of several antennas connected in series. A relatively simple antenna concept with field radiation over the entire length of the antenna suffices, since the antenna is not used for the localization, although this is conceivable in addition.

The antenna preferably is arranged parallel to shelf elements or is used as a shelf element. Depending on the embodiment, the antenna itself is part of the shelf, is used to stabilize it, or is at least installed in the shelf so that it does not interfere with operation, in contrast to a conventional cabling. The antenna can be mounted horizontally or vertically and can detect all RFID transponders in the vicinity over the entire length of a shelf plane or the height of a shelf. Preferably, further antennas arranged in parallel are provided to cover the entire shelf.

The RFID device preferably comprises at least one display element to be arranged at the shelf. Preferably, there is one display element per compartment. Thus, by simple signaling such as red/green, the result of a plausibility check of an inserted transport box can be displayed at the selected compartment. In particular, the reference transponders can be combined with an LED and thus also serve as a display element, wherein the LED can be controlled via RFID communication. More complex displays are also possible, for example a representation of the shelf shown on a screen with marking of shelf compartments, transport boxes, transponders and the like. Other application examples for a display are error messages, display of an occupancy state, presence display of a transport box, display of objects to be removed or refilled, or display of the information read from the transponder. For displaying most of this information, simple blinking or color codes of LEDs are sufficient.

The method in accordance with the invention can be further developed in a similar manner with additional features and shows similar advantages. Such advantageous features are described in an exemplary, but not exclusive manner in the dependent claims following the independent claims.

The invention will be explained in the following also with respect to further advantages and features with reference to exemplary embodiments and the enclosed drawing. The Figures of the drawing show in:

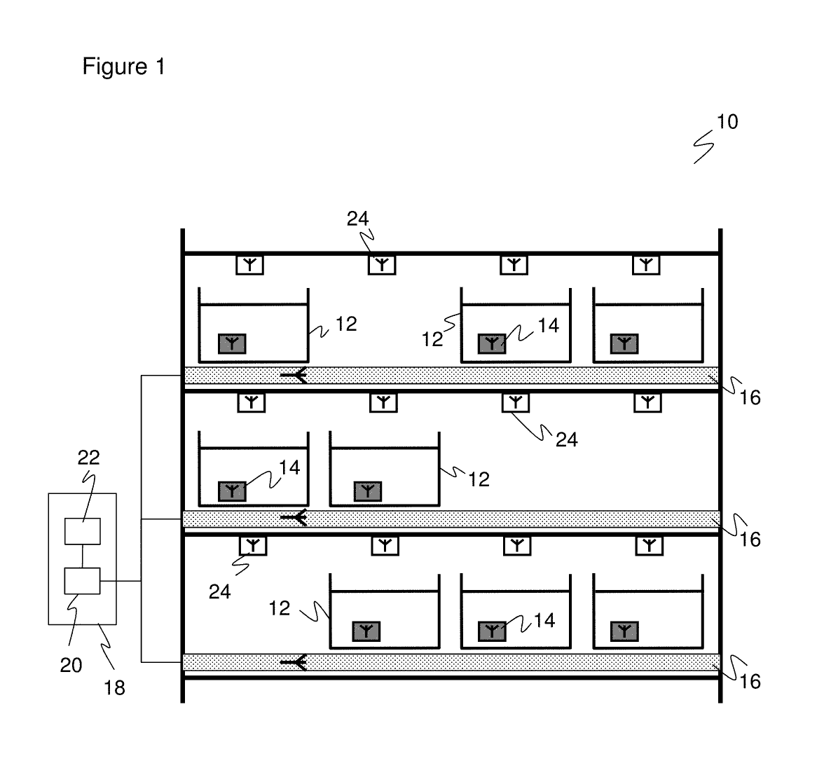

FIG. 1 an overview of a shelf with an RFID apparatus according to the invention;

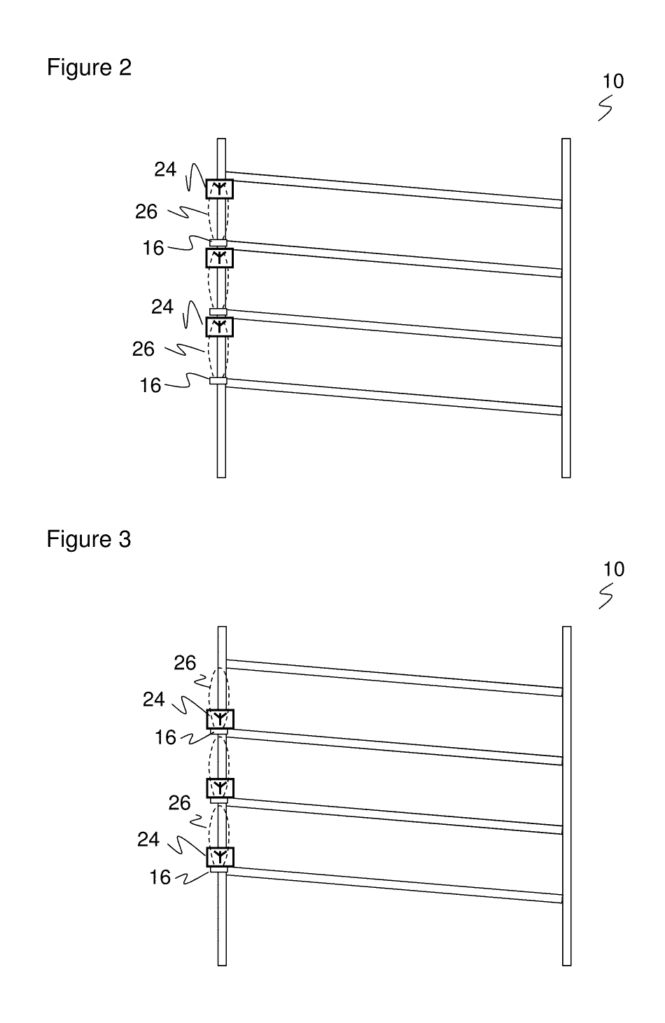

FIG. 2 a side view of the shelf for showing the reading fields and explaining possible positions of reference transponders;

FIG. 3 a side view similar to FIG. 2 with alternative positions of reference transponders;

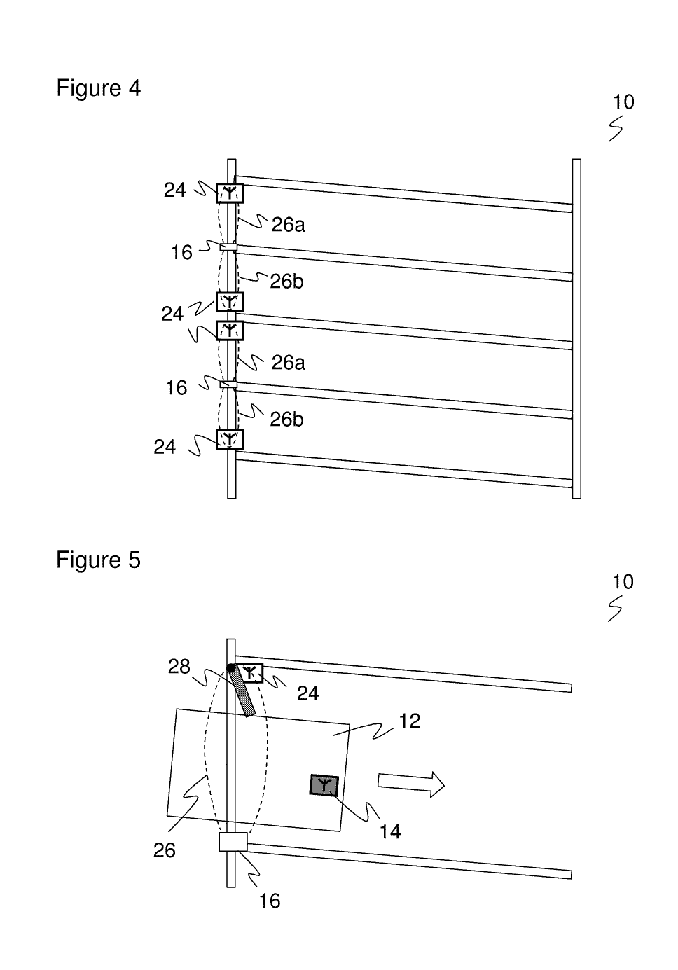

FIG. 4 a representation similar to FIG. 2 of a shelf with alternative reading fields of the respective antennas and still other alternative positions of reference transponders; and

FIG. 5 a section of a side view of the shelf in another embodiment having movable elements in front of the reference transponders.

FIG. 1 shows an overview of a rack or shelf 10 having a plurality of shelves or compartments for containers 12, in particular transport boxes or Kanban containers. In the containers 12, objects are stored, which are not shown. In other embodiments, the compartments may be separated by the shelf 10 itself, or objects may be stored with-out containers 12. The containers 12 and/or the objects stored therein are equipped with transponders 14. For the sake of a simpler language, it is assumed that the transponders 14 are each provided on a respective container 12.

At the shelf 10, several elongated antennas 16 are arranged. These antennas 16 are part of an RFID apparatus 18 which in FIG. 1 is shown as a separate block. As an alternative, it is also possible to at least partially, if not completely, integrate the RFID apparatus 18 into the shelf 10. The RFID reading apparatus 18 comprises an RF transceiver 20, which is connected to the antennas 16, and a control and evaluation unit 22.

Furthermore, a plurality of reference transponders 24 is provided on the shelf 10. For better distinction, the reference transponders 24 are shown in white, while the transponders 14 are shown in dark. In FIG. 1, a reference transponder 24 is shown above each shelf compartment. This may be varied in other embodiments, and reference transponders 24 may be arranged at different positions, with smaller or larger distances, with gaps, or even irregularly.

The RFID device 18 reads the transponders 14 and the reference transponders 24 in a manner known per se. To this end, the functions of a conventional RFID method for example according to ISO 18000-6 are implemented in the control and evaluation unit 22, and the RFID signals required for communication with the transponders 14 and the reference transponders 22 are exchanged via the RF transceiver 20 and the antennas 16.

With this structure, it is possible to detect a container 12 which is inserted into the shelf from the fact that its transponder 14 newly appears in the reading field, and at the same time to localize the container 12 based on the change of the communication characteristics with the reference transponders 24. Analogously, a removed container 12 is detected and localized when a transponder 14 disappears from the reading field.

For this purpose, the control and evaluation unit 22 knows the positions of the reference transponders 24, in particular to which compartment a reference transponder 24 is assigned. This information can be obtained in a teach-in process in which the RFID apparatus 18 queries all the transponders 14, 24 in its surrounding as to whether it is a reference transponder 24 and, if so, which position is stored thereon. Alternatively, this information is parameterized or is provided by a higher-level system, so that its own position does not necessarily have to be stored on a reference transponder 24. The control and evaluation unit 22 also detects and stores the communication characteristics of the RFID communication with the reference transponders 24 as a reference data set, in particular the level (RSSI) and/or the phase angle. This preferably is done cyclically or event-based, for example after a respective localization.

The actual localization is triggered by the addition or removal of a container 12 with a transponder 14. The control and evaluation unit 22 maintains a list of the currently detectable or accessible RFID transponder population, i.e. of transponders 14 in its reading field (inventory), and thus detects when a transponder 14 and consequently the container 12 identified by the transponder 14 is removed or added. Upon such change of the detectable RFID transponder population, the communication characteristics with the reference transponders 24 are again recorded and compared with the reference data set.

By inserting the respective container 12 into the shelf 10, or by removing it, the reading field in the vicinity of the container 12 is at least somewhat changed. This has the effect of corresponding changes in the communication with the reference transponders 24. The control and evaluation unit 22 identifies the reference transponder 24 where the communication has changed by comparison. From this, an assignment of the container 12 to a specific reference transponder 24 and the respective specific compartment is derived. In case the communication characteristics change for more than one reference transponder 24, the selection may for example be based on the largest change. In the extreme case, for example a metallic container 12 which completely blocks the signal path, a reference transponder 24 has completely disappeared from the RFID apparatus' 18 point of view.

Therefore, with the aid of the reference transponders 24, the assignment of objects and containers 12 to a respective compartment or position in the shelf 10 is determined. The RFID reading apparatus 18, or a higher-level system (Warehouse Management, ERP) to which the RFID readings apparatus 18 is connected, thus knows the current respective occupancy of the shelf 10 with containers 12 and objects.

FIG. 2 shows a side view of a shelf 10, which in this example is designed as a Kanban shelf. It is filled from one side, in the representation on the left side, and on the other side containers 12 and generally objects are removed. The slope of the shelf planes causes the containers 12 to slide to the removal side. The RFID apparatus 18 in this embodiment is mounted on the side on which the shelf 10 is filled. Accordingly, the RFID identification, the localization of objects and containers 12 as well as the assignment occur during the filling process.

Due to the arrangement of the RFID device 18 on the filling side, transponders 14 of the inserted containers 12 newly appear from the RFDI apparatus' 18 point of view, with subsequently the respective compartment being determined as described. There is a further possibility for localization when the container 12 slides to the right side and the transponder 14 again disappears from the reading field of the RFID device 18. It is therefore conceivable to localize the container 12 twice upon insertion and sliding away and to compare or combine the results.

In this embodiment, the reference transponders 24 are mounted on the top of the compartments opposite the antennas 16 arranged below. Therefore, inserted containers 12 interrupt the direct signal path and lead to great changes in the communication characteristics. In addition, in the shown embodiment, the antenna lobes 26 preferably are only directed upwards. This can be achieved by means of antennas 16 which have a very narrowly limited reading field (near-field antennas) or which have a very good directivity with a high front-to-back ratio. As a result, RFID transponders 14 are only detected in a dedicated shelf plane per antenna 16. Therefore, an RFID reading of an RFID transponder 14 by a particular antenna 16 can very easily be assigned to a shelf plane, and this information can additionally be used for the localization or the determination of a compartment, respectively.

It is conceivable to mount an RFID apparatus 18 at the other side of the shelf 10, as an alternative or in addition, in order to detect, localize and identify the removal in a manner analogous to the insertion.

FIG. 3 shows a side view of a shelf 10. In this modified embodiment of the RFID apparatus 18, however, the reference transponders 24 are not mounted on top and opposite the antennas 16 arranged below, but on the bottom. In particular, the reference transponders 24 are integrated into the bottom of the respective shelf compartment and are thereby positioned in such a way that the bottom of an inserted container 12 almost touches them. In this case, the change of communication characteristics is caused by detuning the transponder antenna by the material of the container 12. This effect can be optimized by suitable material selection for the bottom of the container 12.

FIG. 4 shows a side view of a shelf 10 with another embodiment of the RFID apparatus 18. In this embodiment, the reference transponders are alternately arranged above and below the shelf planes. In addition, the antennas 16 are preferably modified and now have antenna lobes 26a-b which detect RFID transponders 14 and reference transponders 24 in both the upper and lower shelf planes. In principle, therefore, half as many antennas 16 only for every second shelf plane are sufficient.

FIG. 5 shows an enlarged section of a side view of a shelf 10 with another embodiment of the RFID device 18. A mechanical shielding element 28 is provided for the reference transponders 24 so that, when the container 12 is inserted, the reference transponder 24 is completely or partially covered. The shielding member 28 is preferably conductive to provide a greater effect. The illustrated embodiment as a pivotally mounted sheet metal piece or a flexible piece of spring steel, which folds partially or completely in front of the reference transponder 24 when the container 12 is inserted, is only one example. It merely needs a position-dependent, measurable influence of the shielding element 28 on the communication characteristics which replaces or amplifies the effect of the container 12 itself.

In another embodiment, the reference transponders 24 themselves are moved by the insertion or removal of a container 12. For example, the reference transponder 24 is mounted such that it can be rotated or pivoted, and the inserted or removed container 12 rotates the polarization direction of the reference transponder 24. This generates a significant change in the communication characteristics which can be used for an assignment of the event to the reference transponder 24 and thus a shelf compartment.

A common feature of all embodiments is that they determine the location of a newly identified transponder 14 on a container 12, or a previously read transponder 14 which can no longer be accessed, in that the RFID device 18 detects a reference transponder 24 at a known position in a different way, can no longer detect it or detects it again after a time of disappearance, this respectively resulting in a change of the communication characteristics.

1. An RFID apparatus (18) for compartment occupancy detection in a shelf (10), the RFID apparatus (18) comprising an antenna (16), an RF transceiver (20) connected to the antenna (16) and a control and evaluation unit (22) for communicating with an RFID transponder (14) via the RF transceiver (22) and the antenna (16) by means of an RFID signal and for a detection and localization of changes in the compartment occupancy, the RFID apparatus (18) further comprising a plurality of reference transponders (24) to be arranged on the shelf (10) at known positions, wherein the control and evaluation unit (22) is configured to localize, upon a change of a detectable RFID transponder population, an RFID transponder (14) which is removed or added based on the position of a reference transponder (24) where communication characteristics of the RFID communication have changed together with the change of the detectable RFID transponder population.

2. The RFID apparatus (18) of claim 1,
wherein the communication characteristics comprise at least one of a level and a phase of the RFID signal.

3. The RFID apparatus (18) of claim 1,
wherein the control and evaluation unit (22) is configured for a teach-in of the reference transponders (24) and their positions.

4. The RFID apparatus (18) of claim 1,
wherein the control and evaluation unit (22) is configured to store communication characteristics of the reference transponders (24) as a reference for changes.

5. The RFID apparatus (18) of claim 1,
wherein the control and evaluation unit (22) is configured to maintain a list of the detectable RFID transponder population.

6. The RFID apparatus (18) of claim 1,
wherein the control and evaluation unit (22) is configured to localize the RFID transponder (14) which was removed added based on the position of the reference transponder (24) whose communication characteristics have changed most.

7. The RFID apparatus (18) of claim 1,
wherein the reference transponders (24) are arranged at known intervals along a shelf plane.

8. The RFID apparatus (18) of claim 7,
wherein the intervals are regular.

9. The RFID apparatus (18) of claim 1,
wherein a respective reference transponder (24) is arranged for each shelf compartment.

10. The RFID apparatus (18) of claim 1,
wherein reference transponders (24) are arranged above the shelf compartments.

11. The RFID apparatus (18) of claim 1,
wherein reference transponders (24) are arranged at a bottom of the shelf compartments.

12. The RFID apparatus (18) of claim 1,
wherein movable shielding elements (28) are arranged with the reference transponders (24) which change their position relative to a respective reference transponder (24) when an object (12) is added or removed.

13. The RFID apparatus (18) of claim 1,
wherein the reference transponders (24) are movably arranged on the shelf (10) and change their position when an object (12) is added or removed.

14. The RFID apparatus (18) of claim 1,
wherein the antenna (16) is an elongated antenna extending over the shelf width or shelf height.

15. The RFID apparatus (18) of claim 1,
wherein the antenna (16) is arranged parallel to shelf elements or is used as a shelf element.

16. The RFID apparatus (18) of claim 1,
comprising at least one display element to be arranged at the shelf (10).

17. A method for compartment occupancy detection in a shelf (10), wherein there is an RFID communication with RIFD transponders (14) in the shelf (10) via at least one antenna (16) by means of RFID signals, and a change of compartment occupancy is detected and localized, wherein a plurality of reference transponders (24) is arranged on the shelf (10) at known positions and upon a change of a detectable RFID transponder population an RFID transponder (14) which is removed or added is localized based on the position of a reference transponder (24) where communication characteristics of the RFID communication have changed together with the change of the detectable RFID transponder population.
